(19) United States
(12) Patent Application Publication
(10) Pub. No.: US 2013/0127682 A1
(43) Pub. Date: May 23, 2013

(54) Modular Phased-Array Antenna

(71) Applicants: Niall MacManus, Gerards Cross (GB); Ian Atkinson, Cowes (GB)

(72) Inventors: Niall MacManus, Gerards Cross (GB); Ian Atkinson, Cowes (GB)

(21) Appl. No.: 13/509,393

(22) PCT Filed: Nov. 11, 2010
(86) PCT No.: PCT/GB2010/051883

§ 371 Date: Sep. 20, 2012

(30) Foreign Application Priority Data
Nov. 16, 2009 (GB) 0919953.0

(51) Int. Cl. H01Q 21/06

(52) U.S. Cl. CPC H01Q 21/061
USPC 343/844

(57) ABSTRACT

A modular phased-array antenna including a beam-forming network module, a patch army module, and a marching network module interconnecting the beam-forming network module and the patch array module. The beam-forming network includes suspended stripline passive hybrid and crossover elements configured In a Butler Matrix formation interconnected with transceiver antenna patches via the matching network module which in turn comprises suspended stripline phased-matched tracks and a plurality of oppositely polarised matching elements.

This invention relates generally to antennas for cellular telecommunication networks. Specifically, this invention relates to a phased-array antenna for use at multi-sector network sites.

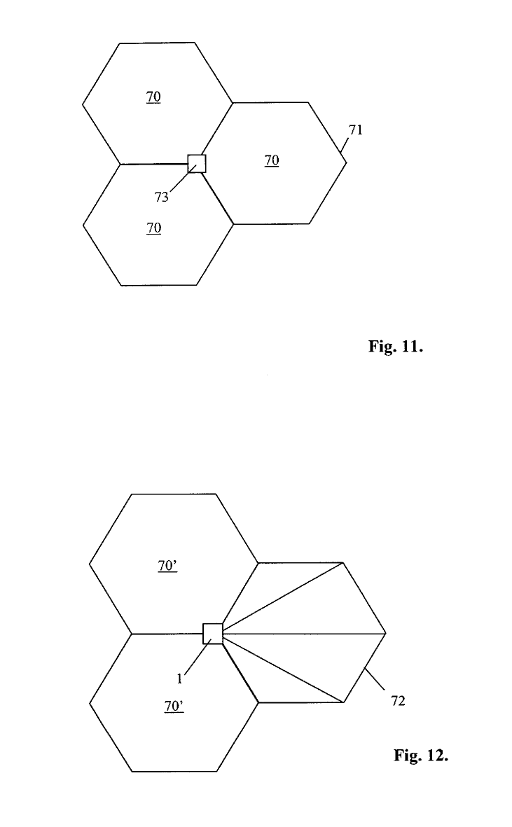

Conventionally, as shown in FIG. 11, a network antenna 73 is situated at the junction of three adjacent network cells 70. Network cell 71 includes an active network user, that is to say someone operating a mobile telecommunications handset or any other network compatible telecommunications terminal within cell 71.

Here, the network antenna 73 transmits to the user, but in doing so must broadcast over the entire cell 71, thus radiating power over an area spanning 120° centred on the network antenna 73. The broadcast power acts as an interference signal for other users within this network cell. In turn, the mobile telecommunications handset, or other such active terminal, transmits omnidirectionally and this is received by the network antenna 73 along with all other transmitted signals from other active users within cell 71.

The prior art system has many limitations. One such limitation arises from the aforementioned spread of antenna-transmitted power over a wide area and the attendant reception by the antenna of a multitude of sent signals from active users. As a result of this, data throughput from active users is limited, and the range of the antenna, for a given operational power output, is restricted, giving an upper limit to the workable size of the network cell.

An object of the present invention is to provide a network antenna that addresses the aforementioned problems and an antenna that enables an increase in the effective data throughput at network sector site locations.

It is a further object of the present invention to provide a network antenna with an increased effective range.

According to an aspect of the present invention there is provided a modular phased-array antenna comprising: a beam-forming network module including a plurality of beam inputs; a patch array module; and a matching network module interconnecting the beam-forming network module and the patch array module.

Preferably, the patch array module includes a plurality of patch elements forming a regular periodic array, and a first ground plane.

In a preferred embodiment, each of the plurality of patch elements comprises a pair of coupled driver patches and at least one parasitic patch separate from the pair of coupled driver patches.

A first dielectric substrate separates the pair of coupled driver patches, and the matching network module comprises: a second dielectric substrate having a first surface supporting a first stripline track; a second surface opposite to said first surface supporting a second stripline track; and a second ground plane.

Preferably, the beam-forming network module comprises: a third dielectric substrate having a first surface supporting a third stripline track and a second surface opposite to said first surface supporting a fourth stripline track; and a third ground plane.

Preferably, the first, the second and said third dielectric substrates are epoxy resin-based dielectric substrates, and the first, second and third ground planes are each supported on a respective epoxy resin-based dielectric substrate.

More preferably, Flame-Retardant 4 board (FR-4) is chosen as the epoxy resin-based dielectric substrate used throughout the antenna.

The beam-forming network module, the patch array module, and the matching network module are interconnected by electrically conductive pins passing through holes in the FR-4 board supporting the first and second ground planes respectively. Furthermore, the first stripline track and the second stripline track are interconnected through electrically conductive vias, the first and second stripline tracks forming a matching network interconnecting the beam-forming network module and the patch elements.

Preferably, the third and fourth stripline tracks are interconnected through electrically conductive vias, the third and fourth stripline tracks including passive hybrid and passive crossover elements.

Advantageously, the passive hybrid and passive crossover elements are configured to form a first Butler Matrix beamformer adapted to produce an output of a first polarisation and a second Butler Matrix beamformer adapted to produce an output of a second polarisation.

In a preferred embodiment of the present invention, the first polarisation is orthogonal to the second polarisation.

Preferably, the pair of coupled driver patches includes a first input pin for receiving the output of a first polarisation and a second pin for receiving the output of the second polarisation, and preferably, the first polarisation is +45° polarised and the second polarisation is −45° polarised.

In a preferred embodiment, the third and fourth stripline tracks are phase-matched tracks connected to the matching network module via output pins.

Preferably, the passive hybrid element and the passive crossover element comprise suspended stripline conductive track having a variable track width.

Preferably, a distance substantially equal to half of the antenna operating wavelength separates adjacent patch elements of the periodic array, and wherein said patch elements are diamond-shaped.

In a preferred embodiment, the first ground plane and the second dielectric substrate are mutually separated by a distance R1, the second dielectric substrate and the second ground plane are mutually separated by a distance R2, the second ground plane and the third dielectric substrate are mutually separated by a distance R3, and the third dielectric substrate and the third ground plane are mutually separated by a distance R4.

Preferably, the above mentioned distances R1, R2, R3 and R4 are each substantially in the range λ/40<Rn<t, where λ is the operating wavelength of the antenna, n=1 to 4, and t is the dielectric substrate thickness.

In a preferred embodiment, the respective thickness t of the first, second and third dielectric substrate is in the range 0.5 mm to 2.0 mm.

An embodiment of the present invention will now be described, by way of example only, with reference to the accompanying schematic drawings, in which:

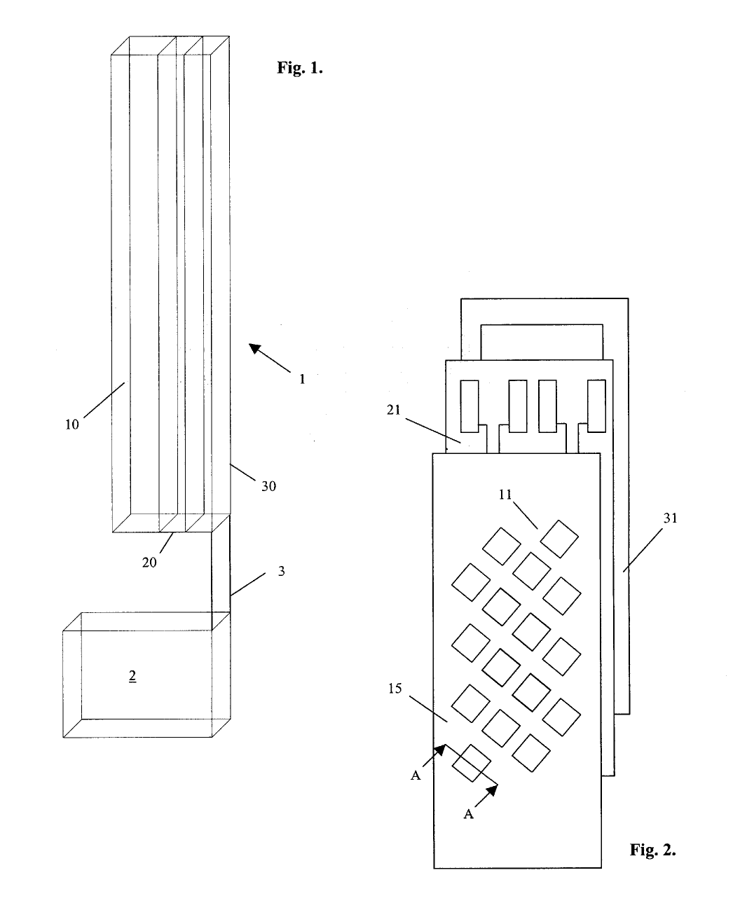

FIG. 1 shows an antenna of the present invention coupled to a network base station;

FIG. 2 is a perspective view of the three main constituent dielectric substrates of the antenna (ground planes are not shown);

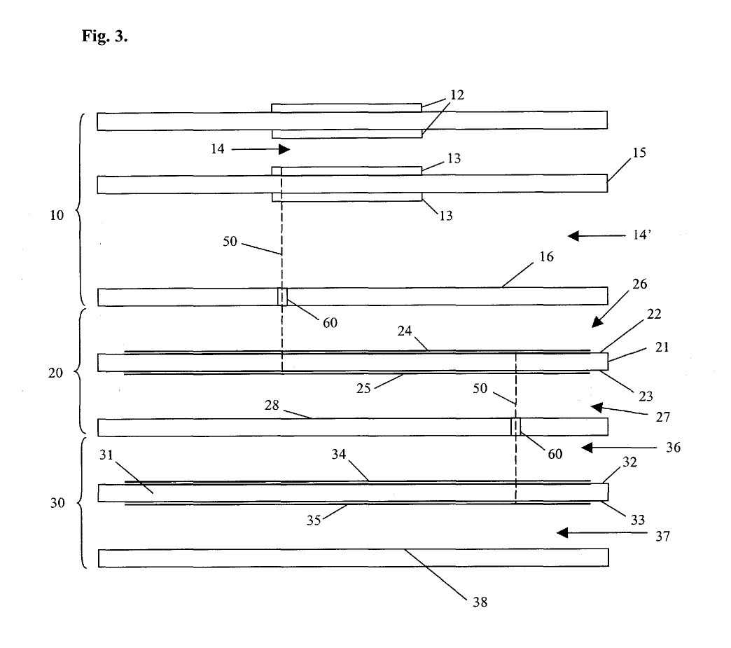

FIG. 3 is a cross-sectional view along the line A-A of FIG. 2 (ground planes included);

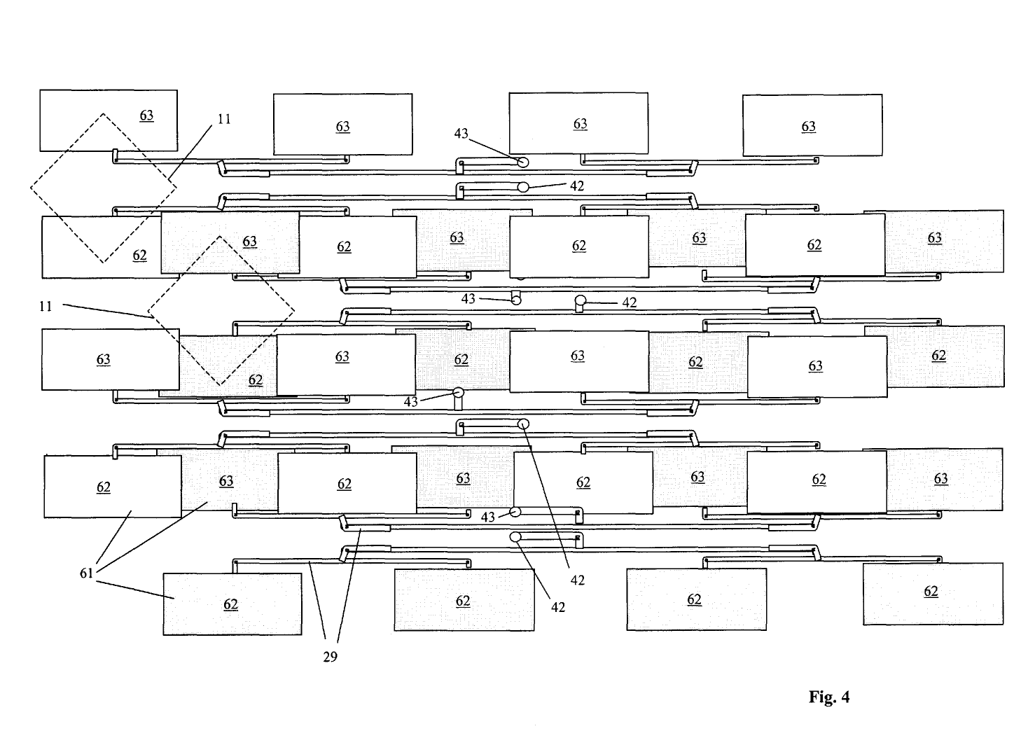

FIG. 4 shows the matching network of the antenna of the present invention;

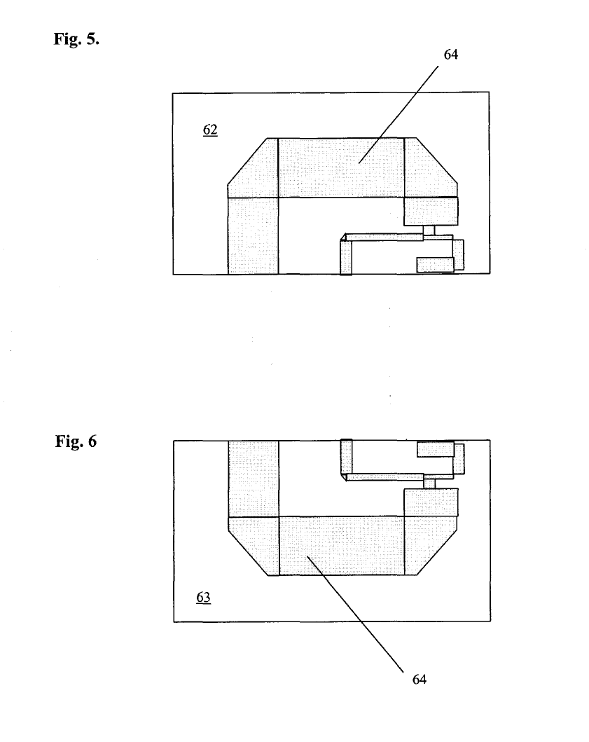

FIG. 5 shows a positive matching element of the matching network module;

FIG. 6 shows a negative matching element of the matching network module;

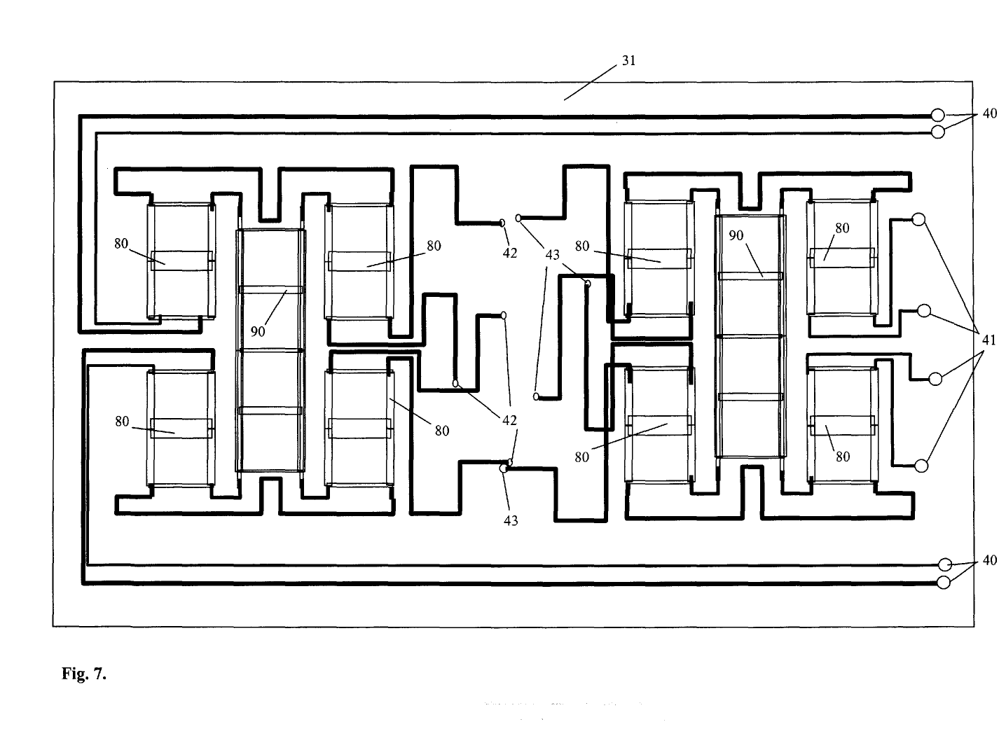

FIG. 7 is a plan view of the beam forming network dielectric substrate;

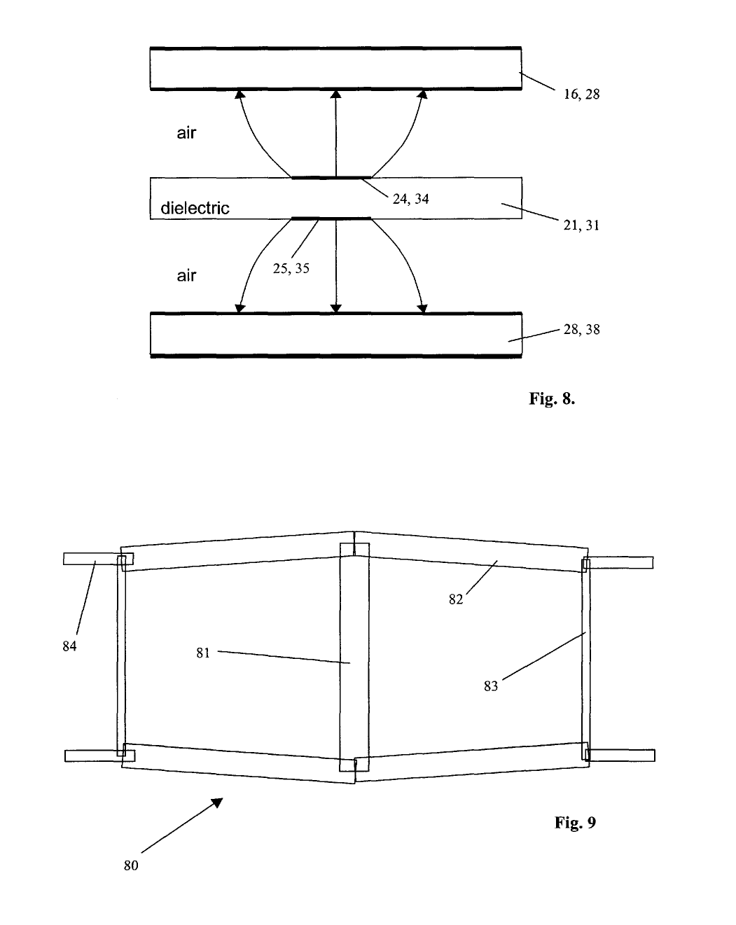

FIG. 8 shows a cross-sectional view of the suspended stripline construction utilised by the antenna of the present invention;

FIG. 9 is a passive hybrid element of the Butler Matrix beamformer;

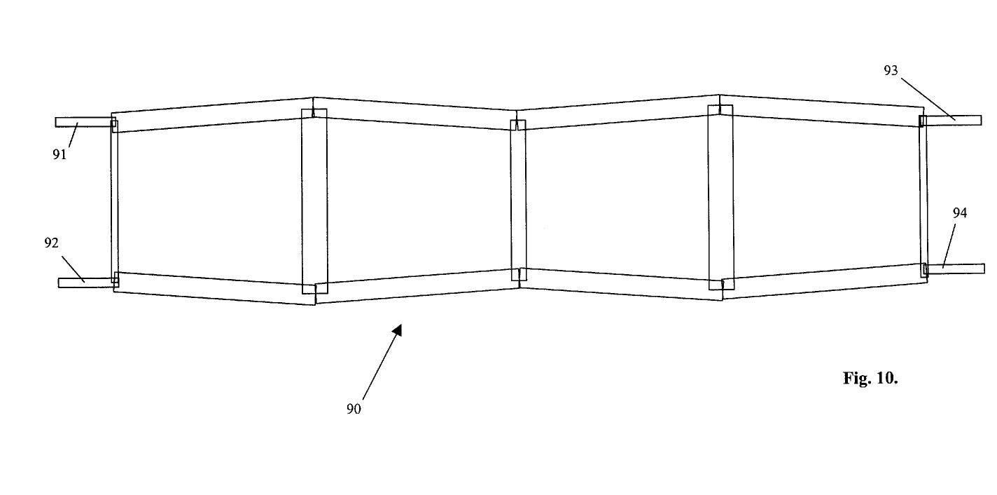

FIG. 10 is a passive crossover element of the Butler Matrix beamformer;

FIG. 11 shows a conventional three-sector cellular network site;

FIG. 12 shows a sectored cellular network site in accordance with the present invention;

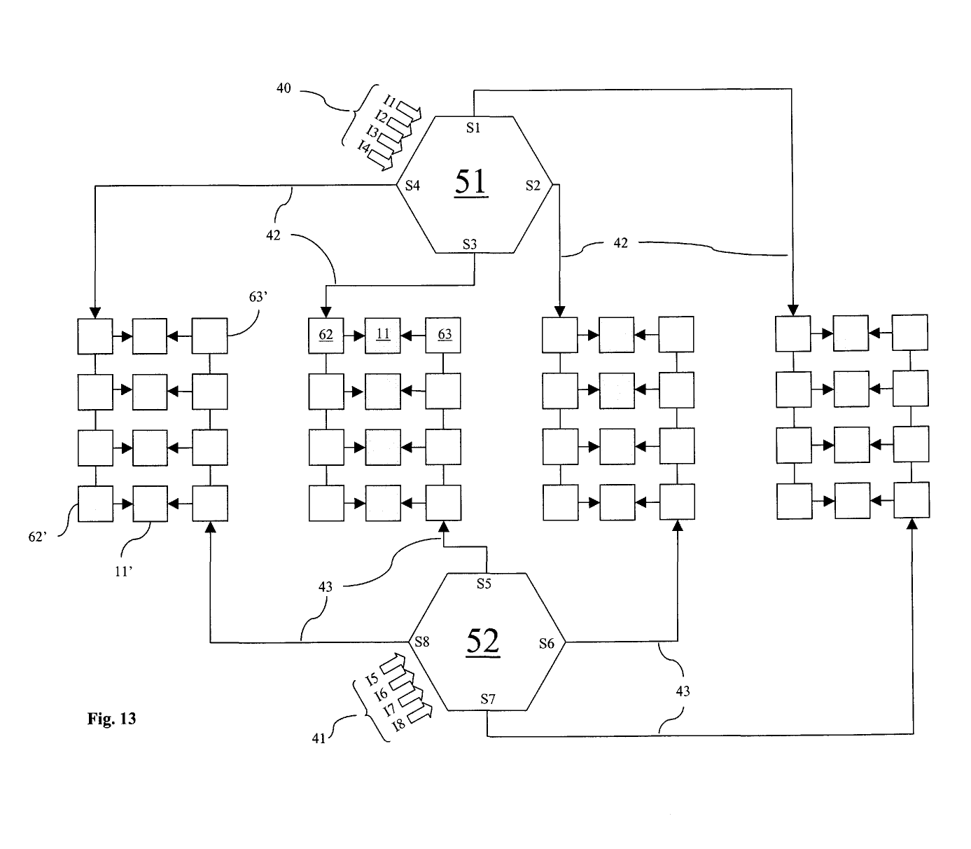

FIG. 13 is a schematic diagram of the antenna in transmit mode;

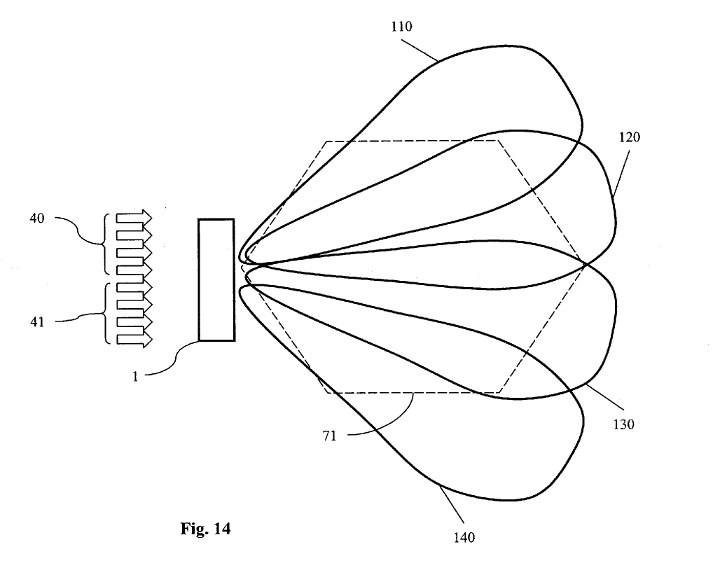

FIG. 14 shows a sectored network cell using four beams;

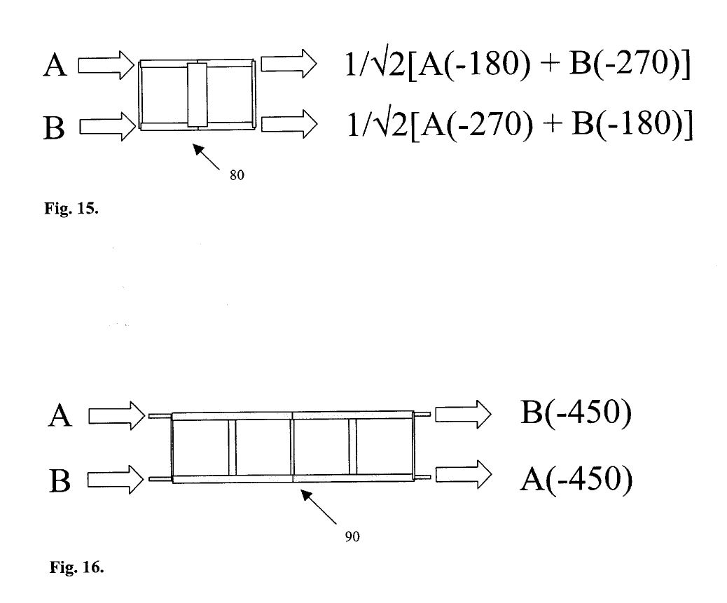

FIG. 15 shows the coupled outputs of a passive hybrid element; and

FIG. 16 shows the outputs of a passive crossover element.

With reference to FIGS. 1, 2 and 3, the antenna 1 comprises three modules: a patch array module 10, a matching network module 20, and a beam-forming network module 30. In use the modules are contained within a metal housing [not shown]. Generally, the housing will include a microwave-transparent window disposed opposite to the patch array module. The antenna is linked to a network base station 2 via a communications link 3.

The patch array module 10 comprises a first substrate 15 and a plurality of patch elements 11 arranged in an offset periodic array. The patch array comprises N columns of M patch elements; the embodiment shown in the figures includes a 4×4 patch array (N×M). Adjacent columns of patch elements 11 are separated by a distance equal to one half of the antenna operating wavelength, λ; separation of the M patch elements within each column is such that the distance is large enough so as to minimise mutual coupling effects, but small enough to maximise compactness. In the embodiment shown the separation between each patch element within a column is less than λ.

Each patch element 11 comprises a pair of conductive driver patches 13 and a pair of parasitic patches 12. However, it is envisaged that in alternative embodiments of the antenna there may be none or more than one parasitic patch pair present in each patch element 11. The driver patches 13 are formed by conductive traces on the dielectric substrate 15. The parasitic patches 12 are also formed as double-sided conductive traces formed on a support substrate. This support substrate may be separated from the dielectric substrate 15 by nylon fastenings or by a layer of expanded low-loss foam.

As shown in FIG. 2 and in broken line in FIG. 4, patch elements 11 are diamond-shaped. However, it should be noted that the patch elements 11 may take any one of a variety of shapes, for example in another embodiment of the antenna the elements are square shaped. The diamond array formation advantageously maximises inter-element spacing thus minimise coupling between elements of the array.

Each parasitic patch 12 is separated from the driver pair by a gap 14. The array of parasitic patches and driver patches are electromagnetically coupled. Advantageously, this facilitates a broadening of the operational bandwidth of the antenna.

Driver patches 13 are formed as conductive traces on the first dielectric substrate 15. In a preferred embodiment the first dielectric substrate 15 is fabricated from FR-4 board having a thickness in the range 0.5 mm to 2.0 mm. It has been found that boards with a thickness within this range are optimised for mechanical rigidity whilst minimising electromagnetic losses.

In alternative embodiments the dielectric substrate can be manufactured from any suitable dielectric material, for example Duroid® laminate. However, it should be noted that such laminate boards are considerably more expensive than FR-4 board, require more costly tooling to fashion, and cannot provide the required mechanical properties whilst maintaining the desired and advantageous rigidity to weight ratio.

The first dielectric substrate 15 is separated from a first ground plane 16 via nylon fastenings [not shown]. The gap 14′ between the first dielectric substrate 15 and the first ground plane 16 is preferably an air gap, but an alternative arrangement is to separate the substrate and ground plane with an expanded low-loss foam.

The ground plane 16, which is also fabricated from FR-4 board, includes a hole 60 through which an electrically conductive pin 50 passes. It should be noted that a plurality of such pins interconnects the patch elements 11 and the feeder module 20, but only one is shown for clarity.

The feeder module 20 comprises a second dielectric substrate 21 and a second ground plane 28. Both the second dielectric substrate 21 and the second ground plane 28 are constructed from FR-4 board. As above, the board thickness is in the range 0.5 mm to 2.0 mm. In order that electromagnetic losses are kept within working tolerances it is preferable that the thickness of the second dielectric substrate 21 is less than one third of a first air gap 26.

The second dielectric substrate 21 includes a first stripline track 24 on an upper surface 22 and a second stripline track 25 on a lower surface 23. Both the first and second stripline tracks are formed on the FR-4 substrates using known lithographic printing and copper etching techniques, or other such plating methods that will be readily known to someone skilled in the art.

In a preferred embodiment, the first stripline track 24 corresponds identically with the second stripline track 25, and both include a plurality of matching elements 60 forming a regular pattern. The first stripline track 24 and the second stripline track 25 are arranged in a suspended stripline configuration [see FIG. 8].

FIG. 4 shows a plan view of the first stripline track 24. The matching elements 60 are arranged into groups of four, with each element in the group interconnected via a feeder track 29. The feeder track 29 linking each group of four matching elements includes beam output pins 42, 43. Output pins 42, 43 connect the output of the beam-forming network module 30 with the stripline tracks of the feeder module 20.

In a preferred embodiment, as shown in FIG. 4, there are a total of 32 matching elements. However, the general formula for the number of matching elements in any embodiment of the antenna is 2×(N×M). The number N, that is to say the number of columns of patch elements, determines the number of beams transmitted from the antenna in the azimuth plane, and the number M determines the beam width of each beam in the elevation plane. In the preferred embodiment the antenna produces 4 beams.

As shown in FIG. 4, the matching network comprises sixteen positive matching elements 62, and sixteen negative matching elements 63. Positive matching elements 62 and negative matching elements 63 are mirror images of one another [see FIGS. 5 and 6]. Positive matching elements 62 receive signal inputs of a given polarisation, and the negative matching elements 63 receive signal inputs with a polarisation that is orthogonal to the signal inputs received by the positive matching elements 63.

Each patch element 11, of which only two are shown in broken line for clarity, includes a pair of conductive input pins [not shown]. One pin is connected to a positive matching element 62 and the other to a negative matching element 63. Consequently, each patch element 11 receives two input signals with orthogonal polarisation from the matching network module 20. In the embodiment shown, each patch element 11 receives a +45° and a −45° polarised input from the matching network module 20.

Referring to FIGS. 5 and 6, each matching element 62 and 63 comprises stripline track 64 arranged as compact network that matches an input signal from the beamformer to an output pin connected to a patch element 11. The stripline track 64 is formed on the upper surface and lower surfaces of the second substrate 21 to form a suspended arrangement [see FIG. 8]. Again, this is produced via known lithographic printing and copper etching techniques.

FIG. 7 shows a third substrate 31 that forms part of the beam forming network module 30. As with the aforementioned first and second stripline tracks 24, 25, a fourth stripline track 35 corresponds identically with a third stripline track 34. However, for clarity only the third stripline track is shown; the reverse surface of the third substrate 31 includes a corresponding stripline pattern. The third stripline track 34 and the fourth stripline track 35 are arranged in a suspended stripline configuration. As mentioned previously, FIG. 8 shows the basic suspended stripline arrangement. When implemented as a microwave transmission line, suspended stripline has many advantages. Chief amongst these advantages is that a suspended stripline is broadband in frequency, and that the electromagnetic fields are spatially constrained so as to allow conductive tracks to be located proximal to one another without incurring significant signal losses. This in turn allows for a compact module design.

The third stripline track 34 includes two beam-forming Butler Matrices. A first beam-former has four signal inputs 40, and a second beam-former has four inputs 41. Consequently, the beam-forming network module 30 has a total of eight inputs [see FIG. 14]. One beam-former feeds four output pins 42, each of which connect to four groups of four positive matching elements 62. The second beam-former feeds four output pins 43 that are in turn connected to four groups of four negative matching elements 63.

As shown in FIG. 7, each beam-former comprises four passive hybrid elements 80 and a single passive crossover element 90. Passive crossover elements 90 facilitate signal crossover without the need for interconnecting cables or wires. The hybrid elements 80 and crossover element 90 are configured in the form of a 4-input Butler Matrix. In a two-beam embodiment of the present invention each beam-former would comprise a single passive hybrid element 80, and in an eight-beam embodiment sixteen passive hybrid elements 80 would be required.

FIG. 8 shows a sectional view of a suspended stripline construction that is utilised in both the beam-forming network module 30 and the matching network module 20. The arrows indicate the typical field pattern in suspended stripline arrangements.

Stripline tracks 24, 25, 34, 35 are suspended between upper ground planes 16, 28 and lower ground planes 28, 38 as shown. An advantage of this suspended stripline arrangement is that electromagnetic fields are spatially constrained to the proximal vicinity of the conductive track. Another advantage is that only a small proportion of the electromagnetic field extends into the dielectric substrate 21, 31, which minimises the influence of the substrates in regard to propagation of transverse electromagnetic waves. Consequently, dielectric substrates that are suitable for use within the antenna are chosen more for their mechanical properties [e.g. strength, weight, thermal expansion coefficient etc.], rather than their electrical properties. An electrical property, such as impedance, can be controlled by varying the width of the stripline tracks.

With reference to FIGS. 9 and 15, each passive hybrid element 80 comprises stripline track segments 81 to 84. Each track segment 81 to 84 has a track width and length that is determined by the desired impedance of the passive hybrid element 80. The passive hybrid element is a broadband element that differs from conventional hybrid elements in that it is operational over a wider frequency bandwidth.

The length of a stripline track segment is equalised for the speed of the transverse electromagnetic wave travelling along the track. A narrow track has a relatively high impedance, however, this results in a higher proportion of the electromagnetic field penetrating the dielectric substrate, giving rise to higher losses and a slowing of the transverse wave velocity. Consequently, the wavelength of the signal travelling along the track is shorter than would be the case for a lower impedance track.

It is desirable that track lengths are whole fractions of the operating wavelength, consequently the tracks must be equalised. For example, if the track segment impedance is 25Ω, the effective wavelength of the signal in the track might be 320 mm, whereas for an impedance of 100Ω the wavelength might change to 310 mm.

In FIG. 9 track segments 81 and 83 have different impedances by virtue of having different track widths. Electrically, track segments 81 and 83 have the same effective fraction of the operating wavelength, but physically they have different lengths. Advantageously, this allows for a much higher performance.

With reference to FIGS. 9 and 15, each passive hybrid element has a pair of inputs and a pair of outputs. For a given pair of inputs having vector magnitudes of A and B respectively, the outputs are as shown in FIG. 15. In this way the passive hybrid element 80 couples the inputs and introduces phase increments to the outputs. A phase increment equal to half a wavelength is denoted as −180 (degrees). Other increments would be represented by an appropriate multiple of 360 degrees, 360 degrees being equal to one complete wavelength.

Similarly, and with reference to FIGS. 10 and 16, each passive crossover element 90, comprises a plurality of stripline track segments the width and length of which are determined by the effective dielectric constant and impedance and phase considerations. Again, as with the hybrid element, the passive crossover element differs from a conventional crossover element in that it operates over a much wider frequency bandwidth. The crossover element includes two inputs 90, 91 and two outputs 93, 94. For a pair of inputs having vector magnitudes of A and B respectively, the outputs are as shown in FIG. 16. Here, the inputs are crossed over and phase increments are introduced as shown.

As show in FIG. 13, in transmit mode the antenna receives signal inputs 40 and 41 from a network base station 2. Inputs 40 and 41 are fed into beamformer 51 and beamformer 52 respectively. In the depicted embodiment, input 40 comprises four +45° polarised signals I1 to I4, and input 41 comprises four −45° degree-polarised signals I5 to I8. It should be noted that +45/−45 are examples only. In practice, any polarisation may be employed, but input 40 will always be in an orthogonal polarisation with respect to input 41.

Beamformer 51 has four outputs S1 to S4, and correspondingly, beamformer 52 has four outputs S5 to S8. Input power from each input I1 to I4 is divided equally between outputs S1 to S4, and correspondingly, input power from each input I5 to I8 is divided equally between outputs S5 to S8. The output phase increments are shown in Table 1.

TABLE 1

| θ | I1/I5 | I2/I6 | I3/I7 | I4/I8 |
|---|---|---|---|---|
| S1/S5 | −45° | 0° | −135° | −90 |
| S2/S6 | −180° | −45° | −90° | 45° |
| S3/S7 | 45° | −19° | −45° | −180° |
| S4/S8 | −90° | −135° | 0° | −45° |

Outputs S1 to S4 are each fed to a group of four positive matching elements 62′. Outputs S5 to S8 are each feed to a group of four negative matching elements 63′. Each group of positive and negative matching elements 62′, 63′ are connected to a group of four patch elements 11′, as shown in FIG. 13.

Beam weights are determined according to the following equation:

$$S ( j ) = {\sum }_{k = 1}^{k = 4} {I}_{k} \frac{{e}^{- j {θ}_{jk}}}{2}$$

Here, S(j) are beamformer outputs, and k represents the inputs 40 or 41. The phase θ is determined from Table 1.

As shown in FIG. 14, the output of the antenna 1 is divided into four beams 110, 120, 130, 140. As a consequence, the cell boundary is extended beyond the extent of the conventional cell 71, and it is sectored into four quadrants by virtue of the four beams 110, 120, 130, 140. In reception mode, the process as described above functions in the reverse.

1. A modular phased-array antenna comprising:
a beam-forming network module including a plurality of beam inputs;
a patch array module; and
a matching network module interconnecting the beam-forming network module and the patch array module.

2. A modular phased-array antenna as claimed in claim 1, wherein the patch array module includes a plurality of patch elements forming a regular periodic array, and a first ground plane.

3. A modular phased-array antenna as claimed in claim 2, wherein each of the plurality of patch elements comprises a pair of coupled driver patches.

4. A modular phased-array antenna as claimed in claim 3, wherein each of the plurality of patch elements further comprises at least one parasitic patch separate from said pair of coupled driver patches

5. A modular phased-array antenna as claimed in claim 3, wherein a first dielectric substrate separates said pair of coupled driver patches.

7. A modular phased-array antenna as claimed in claim 1, wherein the matching network module comprises: a second dielectric substrate having a first surface supporting a first stripline track; a second surface opposite to said first surface supporting a second stripline track; and a second ground plane.

8. A modular phased-array antenna as claimed in claim 1, wherein the beam-forming network module comprises: a third dielectric substrate having a first surface supporting a third stripline track and a second surface opposite to said first surface supporting a fourth stripline track; and a third ground plane.

9. A modular phased-array antenna as claimed in claim 7, wherein said first, said second and said third dielectric substrates are epoxy resin-based dielectric substrates.

10. A modular phased-array antenna as claimed in claim 7, wherein said first, said second and said third ground planes are each supported on a respective epoxy resin-based dielectric substrate.

11. A modular phased-array antenna as claimed in claim 8, wherein said epoxy resin-based dielectric substrates are fabricated from Flame-Retardant 4 board (FR-4).

12. A modular phased-array antenna as claimed in claim 10, wherein the beam-forming network module, the patch array module, and the matching network module are interconnected by electrically conductive pins passing through holes in the FR-4 board supporting the first and second ground planes respectively.

13. A modular phased-array antenna as claimed in claim 7, wherein the first stripline track and the second stripline track are interconnected through electrically conductive vias, the first and second stripline tracks forming a matching network interconnecting the beam-forming network module and the patch elements.

13. A modular phased-array antenna as claimed in claim 12, wherein the third and fourth stripline tracks are interconnected through electrically conductive vias, the third and fourth stripline tracks including passive hybrid and passive crossover elements.

14. A modular phased-array antenna as claimed in claim 13, wherein the passive hybrid and passive crossover elements are configured to form a first Butler Matrix beamformer adapted to produce an output of a first polarisation and a second Butler Matrix beamformer adapted to produce an output of a second polarisation.

15. A modular phased-array antenna as claimed in claim 14, wherein the first polarisation is orthogonal to the second polarisation.

16. A modular phased-array antenna as claimed in claim 15, wherein the pair of coupled driver patches includes a first input pin for receiving the output of a first polarisation and a second pin for receiving the output of the second polarisation.

17. A modular phased-array antenna as claimed in claim 16, wherein the first polarisation is +45° polarised and the second polarisation is −45° polarised.

18. A modular phased-array antenna as claimed in claim 7, wherein the third and fourth stripline tracks are phase-matched tracks connected to the matching network module via output pins.

19. A modular phased-array antenna as claimed in claim 13, wherein the passive hybrid element and the passive crossover element comprise suspended stripline conductive track having a variable track width.

20. A modular phased-array antenna as claimed in claim 2, wherein a distance substantially equal to half of the antenna operating wavelength separates adjacent patch elements of the periodic array, and wherein said patch elements are diamond-shaped.

21. A modular phased-array antenna as claimed in claim 7, wherein the first ground plane and the second dielectric substrate are mutually separated by a distance R1, the second dielectric substrate and the second ground plane are mutually separated by a distance R2, the second ground plane and the third dielectric substrate are mutually separated by a distance R3, and the third dielectric substrate and the third ground plane are mutually separated by a distance R4.

22. A modular phased-array antenna as claimed in claim 21, wherein the distances R1, R2, R3 and R4 is substantially in the range A/40<Rn<t, where A is the operating wavelength of the antenna, n=1 to 4, and t is the dielectric substrate thickness.

23. A modular phased-array antenna as claimed claim 22, wherein the respective thickness t of the first, second and third dielectric substrate is in the range 0.5 mm to 2.0 mm.
